(19) United States
(12) Patent Application Publication
(10) Pub. No.: US 2007/0137357 A1
(43) Pub. Date: Jun. 21, 2007

(54) SHIFT LEVER AND METHOD OF ASSEMBLING THE SHIFT LEVER

(75) Inventor: Shigetoshi Tomida, Aichi-ken (JP)

Correspondence Address: ROBERTS, MLOTKOWSKI & HOBBES, P. O. BOX 10064, MCLEAN, VA, 22102-8064, US

(73) Assignee: KABUSHIKI KAISHA TOKAI-RIKA-DENKI-SEISAKUSHO, Aichi-ken (JP)

(21) Appl. No.: 11/559,541

(22) Filed: Nov. 14, 2006

(30) Foreign Application Priority Data
Nov. 15, 2005 (JP) 2005-329983

(51) Int. Cl. G05G 9/00; G05G 5/00

(52) U.S. Cl. 74/473.1; 74/473.21; 74/473.24

(57) ABSTRACT

A shift lever includes a detent rod on whose upper end portion an operation knob is disposed and a rod holder that holds the detent rod. The rod holder includes: a cylindrical portion through which the detent rod is inserted; a compression spring housing disposed further toward a lower side than the cylindrical portion; a compression spring that is housed in the compression spring housing and biases the detent rod toward the operation knob; and a stopper that abuts on a lower end of the compression spring and supports the compression spring. An opening that enables the compression spring to be inserted from a lower end side of the rod holder is formed in a lower end of the compression spring housing.

### CROSS-REFERENCE TO RELATED APPLICATION

This application claims priority under 35 USC 119 from Japanese Patent Application No. 2005-329983, the disclosure of which is incorporated by reference herein.

### BACKGROUND OF THE INVENTION

1. Field of the Invention

The present invention relates to a shift lever that includes a detent rod that works in conjunction with an operation knob as a result of the operation knob being operated and a rod holder that holds the detent knob, and to a method of assembling the shift lever.

2. Description of the Related Art

A shift lever device is ordinarily disposed in an automobile. A shift lever configuring the shift lever device includes a detent rod that works in conjunction with an operation knob as a result of the operation knob being operated and a rod holder that holds the detent rod. A cylindrical portion, in which an insertion hole through which the detent rod is inserted is formed, is ordinarily disposed in the rod holder (e.g., see Japanese Patent Application Publication No. 6-174060).

A biasing member (which often comprises a spring member) that biases the detent rod toward the operation knob is disposed in this shift lever device. Conventionally, a biasing member seat has been disposed in a lower end portion of the shift lever, and when the biasing member is to be assembled during manufacture of the shift lever device, the biasing member has been inserted from the upper end side (operation knob side) of the cylindrical portion of the rod holder, and then the detent rod has been inserted from the upper end side of the cylindrical portion to assemble the biasing member.

In recent years, making the shift lever thin—that is, giving the shift lever a cross-sectionally flat shape—has been examined in consideration of the design of the shift lever and the like.

However, when the cross section of the shift lever is given a flat shape, it is also necessary to give the insertion hole that had been formed in the cylindrical portion of the rod holder a cross-sectionally flat shape, but when the cross section of the insertion hole is given a flat shape, the biasing member becomes unable to pass through the insertion hole. For this reason, the demand has emerged to give the shift lever a structure where the biasing member is inserted from the lower side of the rod holder—that is, from the lower side of the shift lever—and where the biasing member is supported from the lower side of the shift lever.

### SUMMARY OF THE INVENTION

In view of these circumstances, it is an object of the present invention to provide a shift lever where the biasing member is capable of being inserted from the lower side of the shift lever and where the inserted biasing member is capable of being supported from the lower side of the shift lever.

A first aspect of the present invention provides a shift lever including: a rod holder in which a cylindrical portion for inserting a detent rod is formed; and a detent rod that is held in the rod holder in a state where the detent rod has been inserted through the cylindrical portion, wherein the rod holder includes a biasing member housing disposed further toward a lower side than the cylindrical portion, a biasing member that is housed in the biasing member housing and biases a lower end of the detent rod toward the cylindrical portion, and a support member that abuts on a lower end of the biasing member and supports the biasing member, and an opening that enables the biasing member to be inserted from a lower end side of the rod holder is formed in a lower end of the biasing member housing, so that by attaching the support member, the biasing member inserted through the opening is supported by the support member.

The detent rod may be configured by two members—a detent rod upper portion and a detent rod lower portion—so that, when the detent rod upper portion and the detent rod lower portion are inserted through the cylindrical portion, the detent rod upper portion and the detent rod lower portion engage with each other inside the cylindrical portion.

When the shift lever is to be assembled, first, the detent rod is passed through the insertion hole formed in the cylindrical portion of the rod holder. Then, the biasing member is inserted through the opening in the lower end of the rod holder—that is, through the opening in the lower end of the shift lever—and into the biasing member housing.

Moreover, by attaching the support member, the support member causes the biasing member to maintain the state where it biases the detent rod toward the cylindrical portion.

In this manner, in the above-described aspect, the biasing member is inserted through the opening in the lower end of the shift lever and into the biasing member housing, so that by attaching the support member, the biasing member biases the detent rod toward the cylindrical portion. Consequently, the shift lever is configured such that the biasing member is capable of being inserted from the lower side of the shift lever, and the inserted biasing member is capable of being supported from the lower side of the shift lever.

In the above-described aspect, the cylindrical portion may be formed with a narrower width than that of the biasing member housing, and the detent rod may be insertable from the lower end side of the cylindrical portion.

By making the width of the cylindrical portion narrow in this manner, the groove width of a guide groove that guides the shift lever may be made narrow, which results in the entire shift lever device becoming more compact.

In the above-described aspect, the support member may be attachable and detachable in a direction orthogonal to the cylindrical portion.

Thus, even when the support member receives reaction force from the biasing member, it is difficult for the support member to come out because the support member may be structured such that it is supported by a wall member of the rod holder. Further, workability is good in terms of attaching the support member.

In the above-described aspect, the support member may be attached from the same direction as a detent pin that regulates a vertical-direction position of the detent rod.

Thus, working efficiency at the time of assembly is improved because the support member and the detent pin may be attached from the same direction.

In the above-described aspect, an assembly-use jig may be configured by at least one pair of protruding portions that are separated from each other a predetermined interval and whose distal ends abut on a lower end of the biasing member and a jig body that is continuous from the protruding portions. The at least one pair of protruding portions of the assembly-use jig may be inserted into the biasing member housing through the opening and compress the biasing member a predetermined length, and the support member may be inserted between the one pair of protruding portions, so that the support member is attached to the rod holder.

By predetermined interval is meant an interval through which the support member is insertable. Further, by predetermined length is meant a position where the distal end portion of the support member does not abut against the biasing member even when the space between the protruding portions reaches an insertion position of the support member and the support member is inserted into the rod holder.

In the above-described aspect, when the support member is to be attached, the assembly-use jig may be used to press the biasing member toward the detent rod and compress the biasing member, so that the support member may be attached by inserting the support member between the protruding portions in this pressed state. Consequently, it is remarkably easy to attach the support member when manufacturing the shift lever.

According to the first aspect of the present invention, there can be provided a shift lever where the biasing member is capable of being inserted from the lower side of the shift lever and where the inserted biasing member is capable of being supported from the lower side of the shift lever.

A second aspect of the present invention provides a shift lever assembly method for holding a detent rod in a rod holder in which is formed a cylindrical portion including an insertion hole in a state where the detent rod has been inserted through the cylindrical portion, with a biasing member housing in whose lower end is formed an opening being disposed under the cylindrical portion, the method including: inserting the detent rod through the insertion hole; inserting a biasing member through the opening such that the biasing member is housed in the biasing member housing; and attaching a support member to the rod holder such that the biasing member is maintained in a state where it biases the detent rod toward the cylindrical portion.

### BRIEF DESCRIPTION OF THE DRAWINGS

FIG. 1 is a developed perspective view of a shift lever device described in a first embodiment;

FIGS. 2A and 2B are a perspective view and a plan view of a rod holder of the shift lever device described in the first embodiment;

FIG. 3 is a developed perspective view of an operation knob of the shift lever device described in the first embodiment;

FIGS. 4A and 4B are a plan view and a front view showing an assembly-use jig used when incorporating a stopper in the first embodiment;

FIGS. 5A and 5B are side cross-sectional views showing a compression spring being supported by the stopper in the first embodiment; and

FIG. 6 is a developed perspective view of a shift lever device described in a second embodiment.

### DETAILED DESCRIPTION OF THE INVENTION

Modes for implementing the present invention will be described below by way of embodiments. It will be noted that, in the second embodiment, the same reference numerals will be given to constituent elements that are the same as constituent elements that have already been described, and description of those same constituent elements will be omitted.

### FIRST EMBODIMENT

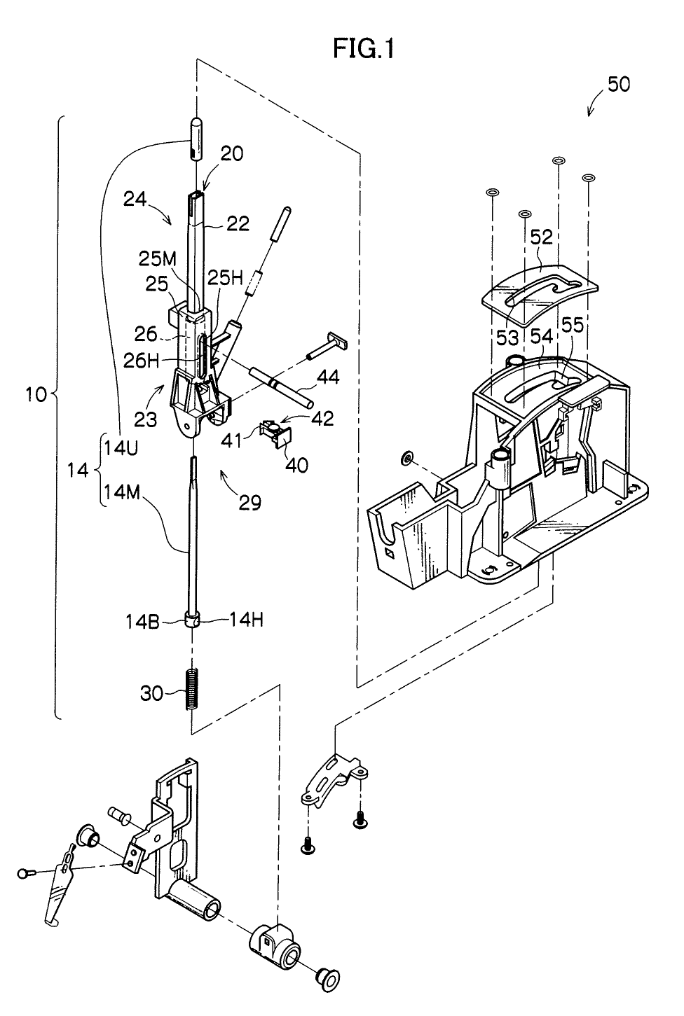

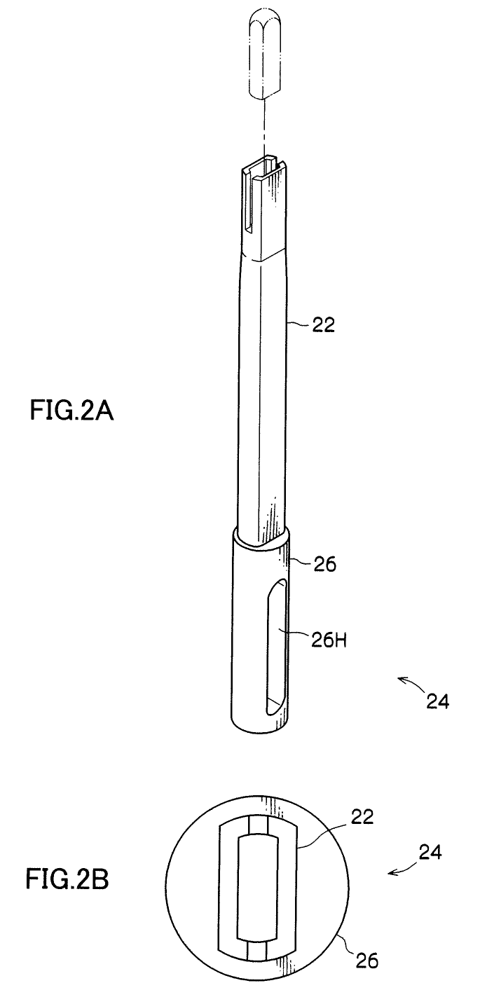

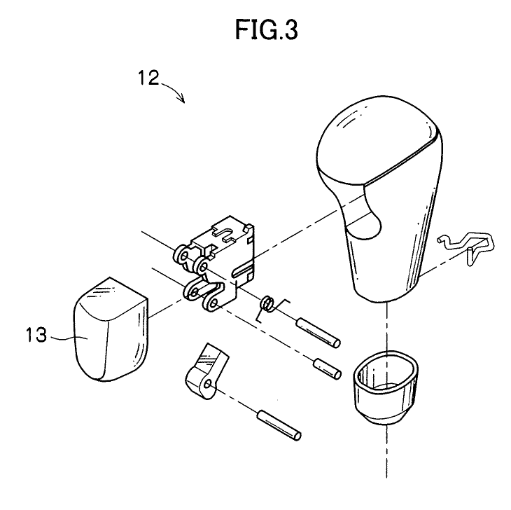

First, a first embodiment will be described. As shown in FIGS. 1 to 3, a shift lever 10 pertaining to the present embodiment includes: a detent rod 14 on whose upper end portion an operation knob 12 (see FIG. 3) is disposed; a rod holder 24 that is made of metal, holds the detent rod 14, and includes a cylindrical portion 22 in which an insertion hole 20 for the detent rod 14 is formed; and a base portion 23 that supports the rod holder 24.

A press portion 13 is disposed in the operation knob 12, and the detent rod 14 goes down when the driver of the automobile presses the press portion 13 with his/her fingers. The cross sections of the detent rod 14 and the cylindrical portion 22 are substantially elliptical, and the detent rod 14 and the cylindrical portion 22 are configured to be thinner than has conventionally been the case. Additionally, the width of the cylindrical portion 22 is configured to be thinner than that of a compression spring housing 26.

Further, a fat-diameter portion 14B that fulfills the role of a stopper with respect to the insertion hole 20 is formed in a lower end portion of the detent rod 14.

The rod holder 24 includes: the compression spring housing 26 that is disposed further toward the lower side than the cylindrical portion 22; a compression spring 30 that is housed in the compression spring housing 26 and biases the detent rod 14 passed through the cylindrical portion 22 toward the operation knob 12 (toward the cylindrical portion 22); a stopper 40 that abuts against the lower end of the compression spring 30 and supports the compression spring 30; and a detent pin 44 that penetrates the compression spring housing 26 and the fat-diameter portion 14B and regulates the position of the detent rod 14 when the detent rod 14 has gone up. Detent pin-use insertion holes 14H and 26H through which the detent pin 44 is inserted are respectively formed in the fat-diameter portion 14B and the compression spring housing 26.

The base portion 23 is molded by resin and integrated with the rod holder 24. A housing retainer 25 that houses and retains the compression spring housing 26 is formed in the upper portion of the base portion 23. A cylindrical portion-use insertion hole 25M through which the cylindrical portion 22 is inserted is formed in the upper portion of the housing retainer 25, and a detent pin-use insertion hole 25H through which the detent pin 44 is inserted is formed at a site in a side wall of the housing retainer 25 corresponding to the detent pin-use insertion hole 26H.

The rod holder 24 is configured to be movable in a two-dimensional direction, and correspondingly a guide groove 53 and a guide groove 55 are respectively formed in a cover 52 and in a guide portion 54 of a shift lever device 50 disposed with the shift lever 10. Switching between shift positions such as park, drive, reverse, and neutral is performed by moving the shift lever 10 along the guide grooves 53 and 55.

An engagement claw 41 that engages with a wall member configuring the compression spring housing 30 is formed on a distal end portion of the stopper 40. The stopper 40 is configured to be attachable and detachable as a result of being inserted and removed in a direction orthogonal to the insertion hole 20. Moreover, a spring seat 42 that supports the compression spring 30 is formed in the stopper 40. Similarly, a spring seat (not shown) is also formed in the lower end of the detent rod 14.

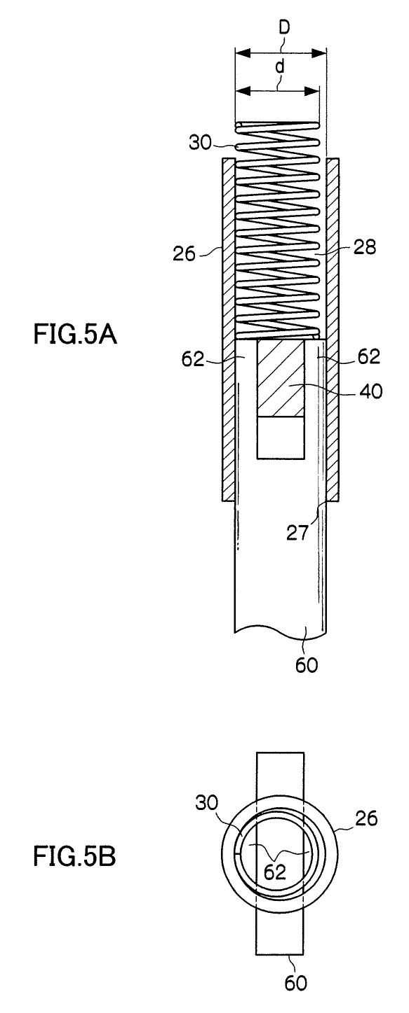

As shown in FIG. 5A, an opening 27 that enables the compression spring 30 to be inserted from the lower end side of the rod holder 24 is formed in the lower end of the compression spring housing 26.

The diameter of the opening 27 is configured to be the same as the inner diameter of the compression spring housing 26. Further, an outer diameter d of the compression spring 30 is configured to be slightly smaller than an inner diameter D of the compression spring housing 26.

It will be noted that the base portion 23 includes, further toward its proximal end side than the compression spring housing 26, an axially supported portion 29 that is axially supported so as to be rotatable, and the opening 27 is formed in the axially supported portion 29.

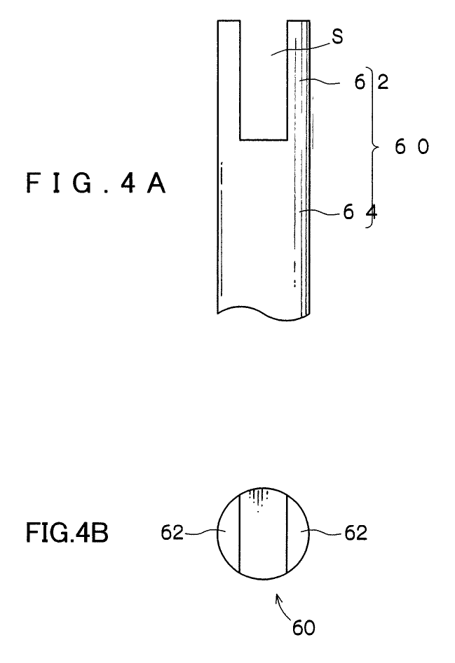

In the present embodiment, an assembly-use jig 60 such as shown in FIG. 4 is used when assembling the shift lever 10. The assembly-use jig 60 is configured by two protruding portions 62, which are separated a predetermined interval from each other and whose distal ends abut against the lower end of the compression spring 30, and a jig body 64, which is continuous with the protruding portions 62. Additionally, when the two protruding portions 62 enter the inside of the compression spring housing 26 through the opening 27 and compress the compression spring 30 a predetermined length, the stopper 40 becomes insertable through a space S between the protruding portions 62.

In the present embodiment, when the shift lever 10 is to be assembled, first, a detent rod body 14M is inserted from the lower side of the insertion hole 20, and a detent rod upper portion 14U is inserted from the upper side of the insertion hole 20 and is caused to engage with the detent rod body 14M. As a result, the detent rod 14 is formed in a state where it has been inserted through the cylindrical portion 22. Further, the detent pin 44 is inserted through the detent pin-use insertion holes 14H and 26H and is fixed.

Then, the compression spring 30 is inserted through the opening 27 in the lower end of the rod holder 24—that is, through the opening 27 in the lower end of the shift lever 10—and into the compression spring housing 26.

Moreover, the assembly-use jig 60 is inserted through the opening 27 to cause the distal ends of the two protruding portions 62 to abut against the lower end of the compression spring 30, and the compression spring 30 is compressed by further inserting the assembly-use jig 60. Then, in a state where the assembly-use jig 60 has been inserted a predetermined distance—that is, until the stopper 40 is capable of being inserted through the space S—the stopper 40 is inserted through the space S by putting in the stopper 40. After the stopper 40 has been set in this manner, the assembly-use jig 60 is removed from the rod holder 24.

As described above, in the present embodiment, the compression spring 30 is inserted through the opening 27 in the lower end of the shift lever 10 and into the compression spring housing 26, so that by attaching the stopper 40, the compression spring 30 is attached such that it biases the detent rod 14 toward the operation knob 12. Consequently, the shift lever 10 is configured such that the compression spring 30 is capable of being inserted from the lower side of the shift lever 10 with a simple configuration, and the inserted compression spring 30 is capable of being supported from the lower side of the shift lever 10. Thus, the cross sections of the cylindrical portion 22 and the detent rod 14 can be given flat shapes, that is, the shift lever 10 can be made thinner than has conventionally been the case.

Further, because the width of the cylindrical portion 22 is configured to be thinner in comparison to the compression spring housing 26, the groove width of the guide groove 53 can be made thinner than has conventionally been the case, which results in the shift lever device 50 becoming more compact.

Moreover, the stopper 40 is attachable and detachable in the direction orthogonal to the cylindrical portion 22. Thus, workability is good in terms of attaching the stopper 40. Further, even when the stopper 40 receives reaction force from the compression spring 30, it is difficult for the stopper 40 to come out because the stopper 40 may be structured such that it is supported by the wall member of the rod holder 24.

Further, the stopper 40 is attached as described above using the assembly-use jig 60. Consequently, it is remarkably easy to attach the stopper 40 when the shift lever 10 is to be manufactured.

Moreover, because the stopper 40 is attached in the same direction as the detent pin 44, the work of assembling the stopper 40 and the detent pin 44 may be performed from the same direction, so that working efficiency is improved.

### SECOND EMBODIMENT

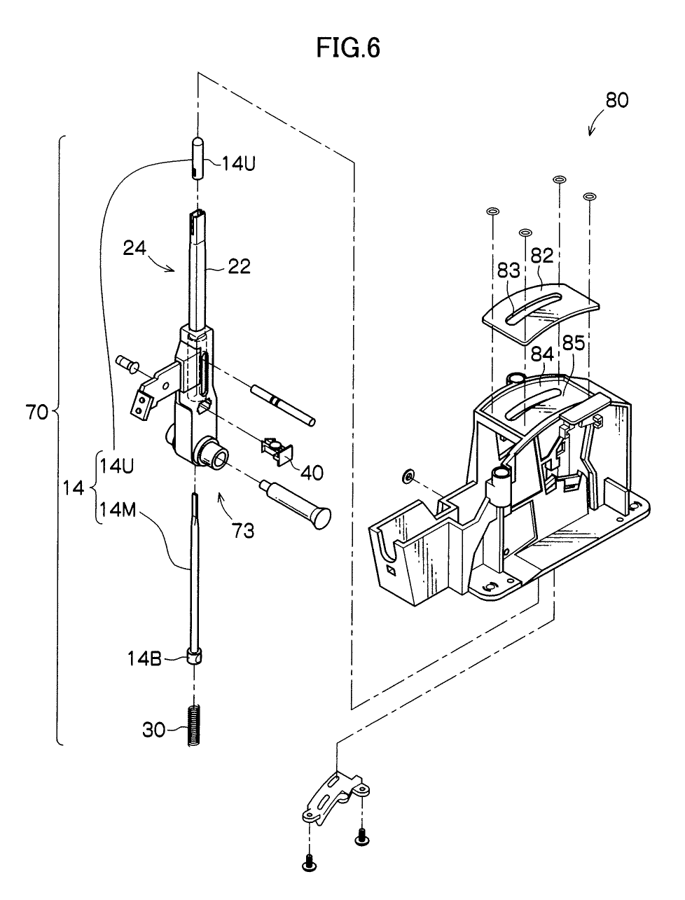

Next, a second embodiment will be described. As shown in FIG. 6, a shift lever 70 pertaining to the present embodiment is disposed with a base portion 73 that is movable only in a one-dimensional direction instead of the base portion 23 in comparison to the first embodiment. Correspondingly, a guide groove 83 and a guide groove 85 are respectively formed in a cover 82 and in a guide portion 84 of a shift lever device 80 to which the shift lever 70 is attached.

According to the present embodiment, it will be understood that the invention is also applicable to a straight-type shift lever.

Modes for implementing the present invention have been described above by way of embodiments, but these embodiments are only examples and may be variously changed and implemented within a range that does not depart from the gist of the invention. It also goes without saying that the scope of rights of the present invention is not limited to the preceding embodiments.

What is claimed is:

1. A shift lever comprising:
a rod holder in which a cylindrical portion for inserting a detent rod is formed; and
a detent rod that is held in the rod holder in a state where the detent rod has been inserted through the cylindrical portion, wherein
the rod holder includes
a biasing member housing disposed further toward a lower side than the cylindrical portion,
a biasing member that is housed in the biasing member housing and biases a lower end of the detent rod toward the cylindrical portion, and
a support member that abuts on a lower end of the biasing member and supports the biasing member, and
an opening that enables the biasing member to be inserted from a lower end side of the rod holder is formed in a lower end of the biasing member housing, so that by attaching the support member, the biasing member inserted through the opening is supported by the support member.

2. The shift lever of claim 1, wherein the cylindrical portion is formed with a narrower width than that of the biasing member housing, and the detent rod is insertable from the lower end side of the cylindrical portion.

3. The shift lever of claim 1, wherein the support member is attachable and detachable in a direction orthogonal to the cylindrical portion.

4. The shift lever of claim 1, wherein the support member is attached from the same direction as a detent pin that regulates a vertical-direction position of the detent rod.

5. The shift lever of claim 1, further comprising an assembly-use jig configured by at least one pair of protruding portions that are separated from each other a predetermined interval and whose distal ends abut on a lower end of the biasing member and a jig body that is continuous from the protruding portions, wherein the at least one pair of protruding portions of the assembly-use jig is inserted into the biasing member housing through the opening and compresses the biasing member a predetermined length, and the support member is inserted between the one pair of protruding portions, whereby the support member is attached to the rod holder.

6. A shift lever assembly method for holding a detent rod in a rod holder in which is formed a cylindrical portion including an insertion hole in a state where the detent rod has been inserted through the cylindrical portion, with a biasing member housing in whose lower end is formed an opening being disposed under the cylindrical portion, the method comprising:
inserting the detent rod through the insertion hole;
inserting a biasing member through the opening such that the biasing member is housed in the biasing member housing; and
attaching a support member to the rod holder such that the biasing member is maintained in a state where it biases the detent rod toward the cylindrical portion.

7. The shift lever assembly method of claim 6, wherein the cylindrical portion is formed with a narrower width than that of the biasing member housing, and the detent rod is insertable from the lower end side of the cylindrical portion.

8. The shift lever assembly method of claim 6, wherein the support member is attachable and detachable in a direction orthogonal to the cylindrical portion.

9. The shift lever assembly method of claim 6, wherein the support member is attached from the same direction as a detent pin that regulates a vertical-direction position of the detent rod.

10. The shift lever assembly method of claim 6, further comprising providing an assembly-use jig configured by at least one pair of protruding portions that are separated from each other a predetermined interval and whose distal ends abut on a lower end of the biasing member and a jig body that is continuous from the protruding portions, wherein the at least one pair of protruding portions of the assembly-use jig is inserted into the biasing member housing through the opening and compresses the biasing member a predetermined length, and the support member is inserted between the one pair of protruding portions, whereby the support member is attached to the rod holder.
